(19) United States
(12) Patent Application Publication
(10) Pub. No.: US 2021/0354974 A1
(43) Pub. Date: Nov. 18, 2021

(54) Locking Drink Container with Lid

(71) Applicants: Amelia Johnson, Palm Bay, FL (US); Nicole Boston, Palm Bay, FL (US)

(72) Inventors: Amelia Johnson, Palm Bay, FL (US); Nicole Boston, Palm Bay, FL (US)

(21) Appl. No.: 17/322,104

(22) Filed: May 17, 2021

Related U.S. Application Data
(60) Provisional application No. 63/025,216, filed on May 15, 2020.

(51) Int. Cl. B67D 1/08; B65D 43/02

(52) U.S. Cl. CPC B67D 1/0808; G07C 9/00174; B65D 43/0204

(57) ABSTRACT

A locking drink container with a lid is shown and comprised. The locking drink container with lid includes a container housing having a base and at least one sidewall rising therefrom. A spout is connected through the sidewall such that the spout is fluidly connected to the interior of the container. A lid which is configured to be removably secured to the side of the at least one sidewall opposite the base. A locking device is secured to the lid, wherein the locking device includes at least one locking dial on a top side of the lid and a plurality of locking structures on a bottom side of the lid.

### CROSS REFERENCE TO RELATED APPLICATIONS

This application claims the benefit of U.S. Provisional Application No. 63/025,216 filed on May 15, 2020 The above identified patent application is herein incorporated by reference in its entirety to provide continuity of disclosure.

### BACKGROUND OF THE INVENTION

The present invention relates to a locking drink container. More particularly, the present invention provides a drink container with a lid that has the ability to lock to the container closed.

Many people drink tea or other beverages from drink dispensing containers. In some instances, these containers are opened to the public. Specifically, some restaurants have containers filled with beverages for sale that are open to the public. A customer is free to choose the beverage from a container which matches their individual preferences. However, as the beverage in the containers are open to the public, anyone is able to tamper not only with the container but with the beverage itself.

In some instances, the interior of the container itself could be easily be tampered with, without proper preventative procedures or mechanisms in place. Absent such a suitable mechanism, poisons, needles, drugs, or any of a variety of harmful materials could be dropped into the container and no one would know. Additionally, such open containers can be utilized by terrorists or anyone else trying to hurt innocent people.

Consequently, there is a need for an improvement in the art of public drink containers. The present invention substantially diverges in design elements from the known art while at the same time solves a problem many people face when having an unattended drink container. In this regard the present invention substantially fulfills these needs.

### SUMMARY OF THE INVENTION

The present invention provides a locking drink container with lid wherein the same can be utilized for providing convenience for the user when using a public drink container with a lid. The locking drink container with lid is comprised of a container housing having a base and at least one sidewall rising therefrom. A spout is connected through the sidewall to the interior of the container. A lid is configured to be removably secured to the side of the at least one sidewall opposite the base. A locking device is secured to the lid, wherein the locking device is comprised of at least one locking dial on a top side of the lid and a plurality of locking structures on a bottom side of the lid.

Another object of the locking drink container with a lid is to have a manual locking dial.

Another object of the locking drink container with a lid is to have an electronic locking dial.

Another object of the locking drink container with a lid is to have a turn wheel located on the top side of the lid, wherein the turn wheel is movably attached to the locking structures such that the structures will be retracted or extended with a turn of the turn wheel.

Another object of the locking drink container with a lid is to have locking devices which are locking bolts.

Another object of the locking drink container with a lid is to have locking devices which are locking projections.

Another object of the locking drink container with a lid is to have a plurality of apertures located within the at least one sidewall near the end opposite the base.

Another object of the locking drink container with a lid is to have a portion of the lid that secures within the interior of the container.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the locking drink container with lid.

FIG. 2 shows a perspective view of an alternative embodiment of the locking drink container with lid.

FIG. 3 shows a perspective view of an embodiment of a drink container for use with the locking drink container with lid.

FIG. 4 shows a bottom up view of an embodiment of the locking drink container lid.

FIG. 5 shows an exploded view of an alternative embodiment of a drink container and a locking lid.

### DETAILED DESCRIPTION OF THE INVENTION

Reference is made herein to the attached drawings. Like reference numerals are used throughout the drawings to depict like or similar elements of the locking drink container with lid. For the purposes of presenting a brief and clear description of the present invention, a preferred embodiment will be discussed as used for the locking drink container with lid. The figures are intended for representative purposes only and should not be considered to be limiting in any respect.

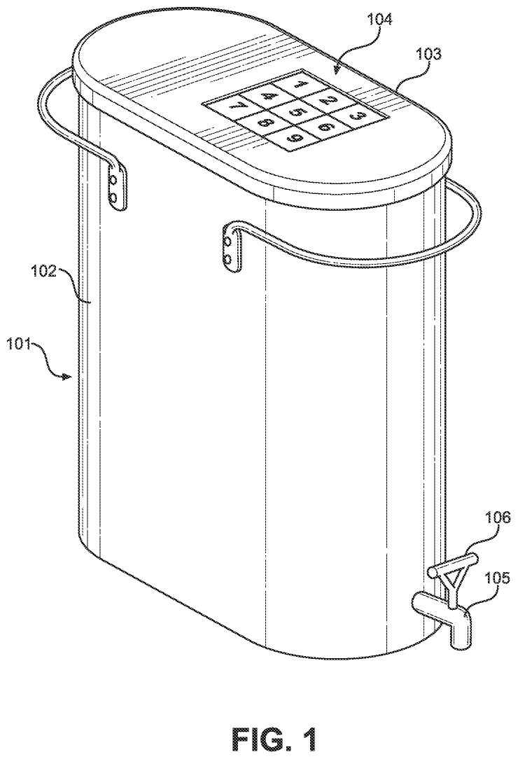

Referring now to FIG. 1, there is shown a perspective view of an embodiment of the locking drink container with a lid. The locking drink container with a lid is comprised of a container 101. The container 101 has a base and at least one sidewall 102 rising therefrom. This will create an interior volume within the container 101. The container 101 has an open end opposite the base. A lid 103 as described herein will be configured to fit onto the container and be locked in place.

In one embodiment, there is an electronic keypad 104 secured to the top of the lid 103. The electronic key pad 104 will allow a user to input a key code and activate the locking device as later described. This will allow a user to unlock and remove the lid 103 as desired.

The container 101 further includes a pour spout 105. In one embodiment, the pour spout 105 is secured to the at least one sidewall 102. The pour spout 105 is fluidly connected to the interior of the container 101. This will allow for liquids to be dispensed from the container via the pour spout 105. In one embodiment the pour spout 105 includes an activation device 106. The activation device 106 will open the pour spout 105 releasing liquid.

In the illustrated embodiment, the container 101 further comprises a pair of handles 107. The pair of handles 107 are disposed on each side of the container 101. As such, the user will be able to lift and move the locking drink container using the pair of handles 107. The pair of handles 107 may be placed at the top of the container 101 as illustrated, or may be placed at an alternate position as desired.

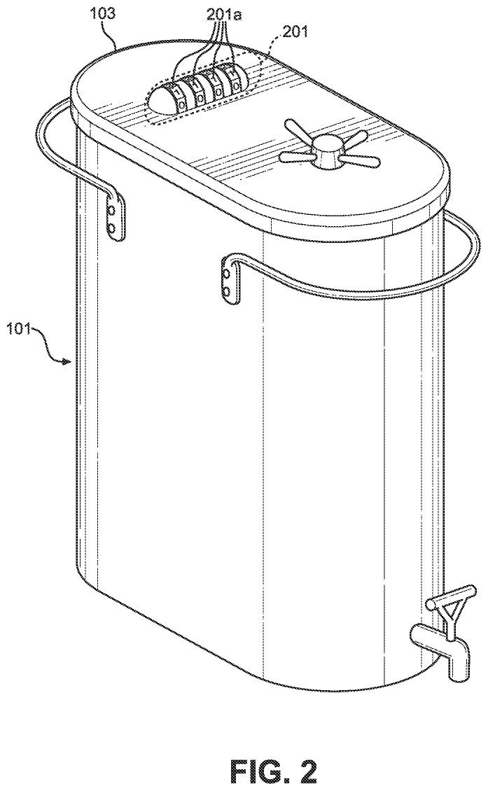

Referring now to FIG. 2, there is shown a perspective a perspective view of an alternative embodiment of the locking drink container with lid. In an alternative embodiment, the lid 103 of the container 101 includes at least one combination dial 201. In the shown embodiment there are 4 dials 201a shown. Each of these dials 201a represent a number to a combination to allow the lid 103 to be removed when properly entered.

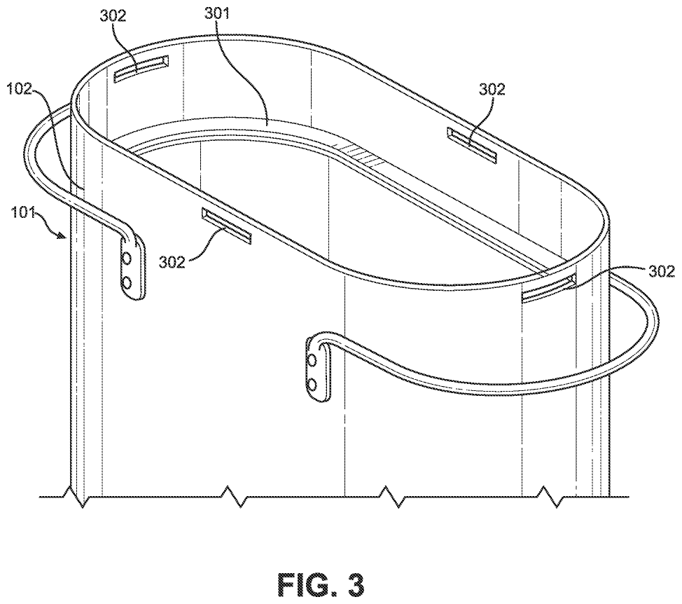

Referring now to FIG. 3, there is shown a perspective a perspective view of an embodiment of a drink container for uses with the locking drink container with lid. In one embodiment, the lid is configured to fit at least partially within the container 101. In one embodiment, the interior of the at least one sidewall 102 includes a ledge 301. The ledge 301 will protrude from the interior of the at least one sidewall 102 into the interior volume of the container 101. The ledge 301 will function as a stopper to prevent the lid in some embodiments from falling into the container 101. In other embodiments, the ledge 301 will simply provide additional support to the lid.

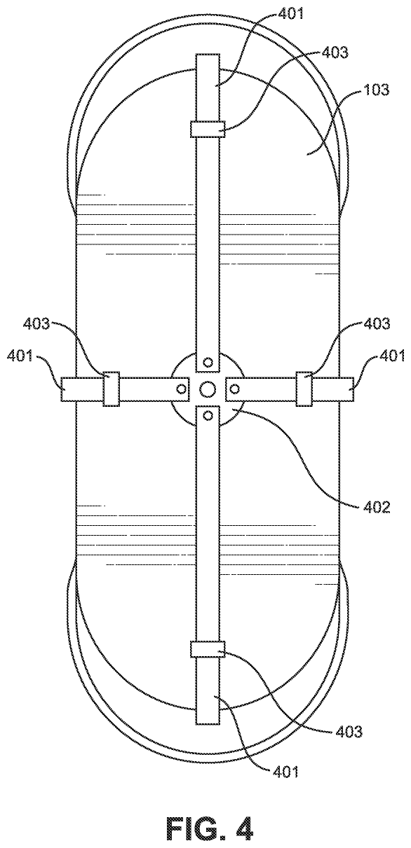

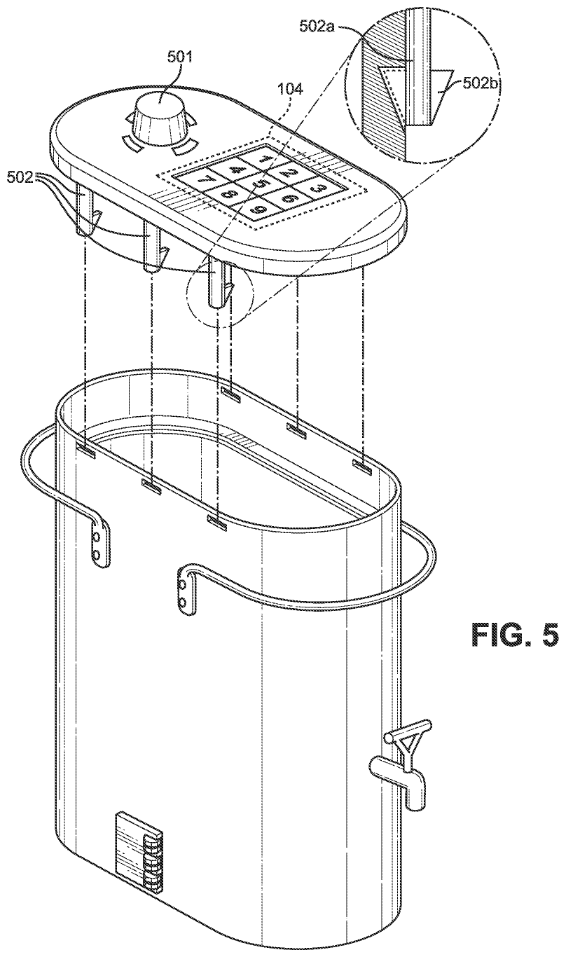

In some embodiments, the ledge 301 will further allow for lock bolts to be secured thereunder. The lock bolts will be fully described in the description of FIG. 4 and FIG. 5. This will prevent removal of the lid. In another embodiment there is a plurality of apertures 302 located through the at least one sidewall 102. The plurality of apertures 302 will allow for the lock bolts to be secured therein preventing removal of the lid.

Referring now to FIG. 4, there is shown a bottom up view of an embodiment of the locking drink container lid. In one embodiment, the locking device in addition to the combination entry devices described above further includes locking bolts 401. In the shown embodiment there are four locking bolts 401. The locking bolts 401 are rotatably coupled to a central disk 402. The central disk 402 is coupled to the locking device such that it may rotate when the proper combination is put into the combination entry devices. The locking bolts 401 are further slidably disposed through bolt brackets 403. This will retain the locking bolts 401 against the lower surface of the lid 103 and allow the locking bolts 401 to slide through the bolt brackets 403.

In use, in order to have the locking bolts 401 secure the lid 103 to the container the combination is entered into the combination entry device. This will trigger an electric device to spin the central disk 402. The locking bolts 401 will then extend through the apertures of the container as previously described. This will secure the lid 103 to the container. In order to remove the lid 103, the combination shall be entered again. The central disk 402 will spin pulling the locking bolts inward from the apertures.

Referring now to FIG. 5, there is shown an exploded view of an alternative embodiment of a drink container and a locking lid. In one embodiment the locking device further includes a turn knob 501. The turn knob 501 is operably coupled to the locking device such that it is able to be spun when a proper combination is input into the combination entry device which is shown as an electronic keypad 104. In one embodiment, this will extend the locking bolts as described above. In another embodiment, this will extend locking hooks 502 as described below.

In one embodiment, the locking device includes a plurality of locking hooks 502. Each of the locking hooks 502 are comprised of an elongated member 502a. The elongated member 502a is secured at one end to the lid 103. At the opposite end there is a retracting hook member 502b. The retracting hook member 502b is pivotally connected to the elongated member 502a such that it may be retracted into the elongated member 502a. In one embodiment the hook member 502b is operably coupled to the turn knob 501. In other embodiments the hook member 502b is coupled to an electronic retraction device.

In one embodiment there are apertures 503 located within the ledge. These apertures 503 are configured to accept the elongated members 502a of the locking hooks 502 therethrough. The hook members 502b are then extended and the lid 103 will be secured in place. In another embodiment the locking hooks 502 are configured to fit within the container 101 adjacent to the ledge. The hook members 502b will then be extended beneath the ledge and lock the lid 103 into place. In yet another embodiment the apertures 302 located within the at least one sidewall 102 are configured to accept the hook members 502b therein. This will lock the lid 103 into place.

In the illustrated embodiment, the locking drink container further comprises a date keeper 504. The date keeper 504 comprises a plurality of dials configured to present a date defined by the user. For example, the date keeper 504 may comprises dials corresponding to a day, a month and a year. The date keeper 504 will allow for the user to ensure that the contents of the locking drink container are fresh and safe for consumption.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A locking drink container with a lid, the container comprising,
a container housing having a base and at least one sidewall rising therefrom;
a spout connected through the sidewall to the interior of the container;
a lid configured to be removably secured to the side of the at least one sidewall opposite the base;
a locking device secured to the lid, wherein the locking device is comprised of at least one manual locking dial on a top side of the lid and a plurality of locking structures on a bottom side of the lid.

2) The locking drink container with a lid of claim 1, further comprising a turn wheel located on the top side of the lid, wherein the turn wheel is movably attached to the locking structures such that the structures will be retracted or extended with a turn of the turn wheel.

3) The locking drink container with a lid of claim 1, wherein the locking devices are locking bolts.

4) The locking drink container with a lid of claim 1, wherein the locking devices are locking projections.

5) The locking drink container with a lid of claim 1, further comprising a plurality of apertures located within the at least one sidewall near the end opposite the base.

6) The locking drink container with a lid of claim 1, wherein at least a portion of the lid fits within the interior of the container.

7) A locking drink container with a lid, the container comprising,
a container housing having a base and at least one sidewall rising therefrom;
a spout connected through the sidewall to the interior of the container;
a lid configured to be removably secured to the side of the at least one sidewall opposite the base;
a locking device secured to the lid, wherein the locking device is comprised of at least one digital dial on a top side of the lid and a plurality of locking structures on a bottom side of the lid.

8) The locking drink container with a lid of claim 7, further comprising a turn wheel located on the top side of the lid, wherein the turn wheel is movable attached to the locking structures such that the structures will be retracted or extended with a turn of the turn wheel.

9) The locking drink container with a lid of claim 7, wherein the locking devices are locking bolts.

10) The locking drink container with a lid of claim 7, wherein the locking devices are locking projections.

11) The locking drink container with a lid of claim 7, further comprising a plurality of apertures located within the at least one sidewall near the end opposite the base.

12) The locking drink container with a lid of claim 7, wherein at least a portion of the lid fits within the interior of the container.

13) The locking drink container with a lid of claim 7, wherein the locking devices are electronically retracted or extended.
